(19) United States
(12) Patent Application Publication
(10) Pub. No.: US 2018/0023601 A1
(43) Pub. Date: Jan. 25, 2018

(54) Post Clamp

(71) Applicant: WeatherSure Systems, Inc., Denver, CO (US)

(72) Inventors: Rodney Owens, Denver, CO (US); Phillip Owens, Denver, CO (US)

(21) Appl. No.: 15/655,162

(22) Filed: Jul. 20, 2017

Related U.S. Application Data
(60) Provisional application No. 62/365,556, filed on Jul. 22, 2016.

(51) Int. Cl. F16B 2/12; F16L 37/12; F16M 13/02; F16B 7/04

(52) U.S. Cl. CPC F16B 2/12; F16B 7/0406; F16L 37/1225; F16M 13/02

(57) ABSTRACT

A post clamp is disclosed as it may include one or more buffer components. In an example, each buffer component has a first shape on a post side and a second shape on a strap side. The post side is substantially flat and the strap side is substantially arc shaped. In an example, the post clamp also includes a fastener configured to strap the at least one buffer component against a post to secure the at least one buffer component to the post. In an example, the strap side of each of the buffer components has ridges forming a valley between the ridges. The fastener is configured to sit within the valley between the ridges so that the ridges maintain the fastener each of the buffer components and keep the fastener from slipping partially or fully off of the buffer components.

### PRIORITY CLAIM

This application claims priority to U.S. Provisional Patent Application No. 62/365,556 filed Jul. 22, 2016, titled “Post Clamp” of Rodney Owens and Phillip Owens; hereby incorporated by reference in its entirety as though full set forth herein.

### BACKGROUND

Posts and tubing (e.g., HVAC) are often installed in commercial and residential properties. Various operations require water-tight seals around these posts and tubing. Typically, this is achieved using uncured rubber affixed to the post or tubing. This can be messy and may not provide a completely water-tight seal.

### BRIEF DESCRIPTION OF THE DRAWINGS

FIG. 1 is a top perspective view of an example post clamp.

FIG. 2 is a bottom perspective view of the example post clamp,

FIG. 3 is a rear view corresponding to FIG. 1.

FIG. 4 is a front view corresponding to FIG. 1.

FIG. 5 is a right-side view corresponding to FIG. 1.

FIG. 6 is a left-side view corresponding to FIG. 1.

FIG. 7 is a top view corresponding to FIG. 1.

FIG. 8 is a bottom view corresponding to FIG. 1.

FIG. 9 is a top perspective view of multiple post clamps corresponding to the post clamp of FIG. 1 combined with a hose clamp to fit about a square post.

FIG. 10 is a bottom perspective view corresponding to FIG. 9.

FIG. 11 is a front view corresponding to FIG. 9.

FIG. 12 is a rear view corresponding to FIG. 9.

FIG. 13 is a right-side view corresponding to FIG. 9.

FIG. 14 is a left-side view corresponding to FIG. 9.

FIG. 15 is a top view corresponding to FIG. 9.

FIG. 16 is a bottom view corresponding to FIG. 1.

FIG. 17 is a perspective view of the post clamp as it may be secured to a post.

### DETAILED DESCRIPTION

A post clamp is disclosed. An example post clamp may include one or more buffer components. In an example, each buffer component has a first shape on a post side and a second shape on a strap side. The post side is substantially flat and the strap side is substantially arc shaped. The post clamp may also include a fastener configured to strap the at least one buffer component against a post to secure the at least one buffer component to the post.

In an example, the strap side of each of the buffer components has ridges forming a valley between the ridges. The fastener is configured to sit within the valley between the ridges so that the ridges maintain the fastener each of the buffer components and keep the fastener from slipping partially or fully off of the buffer components.

The example post clamp may provide a water-tight seal around posts and tubing. In an example, the post clamp is configured for square or rectangular posts and tubing. The post clamp may be adjustable (e.g., cut to size or otherwise) and/or may be provided in various sizes and/or implemented with various size posts, tubing, etc. In an example, the post clamp can be implemented in the roofing industry, however, use of the post clamp is not limited to any particular end use. Other configurations and/or applications of the post clamp disclosed herein will be readily apparent to those having skill in the art after becoming familiar with the teachings herein.

It is noted that the examples described herein are provided for purposes of illustration, and are not intended to be limiting. Other devices and/or device configurations may be utilized to carry out the operations described herein. Operations shown and described herein are provided to illustrate example implementations. However, the operations are not limited to those shown or described and other operations may also be implemented. Variations will become readily apparent to those having ordinary skill in the art after becoming familiar with the teachings herein.

Before continuing, it is noted that as used herein, the terms “includes” and “including” mean, but is not limited to, “includes” or “including” and “includes at least” or “including at least.” The term “based on” means “based on” and “based at least in part on.”

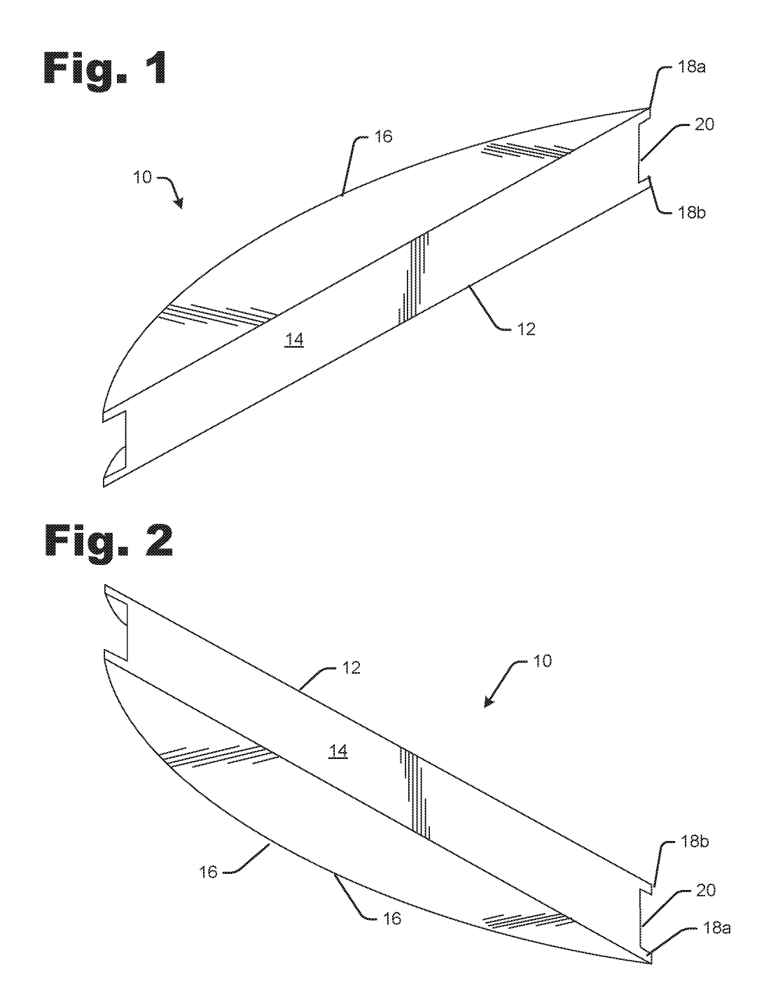

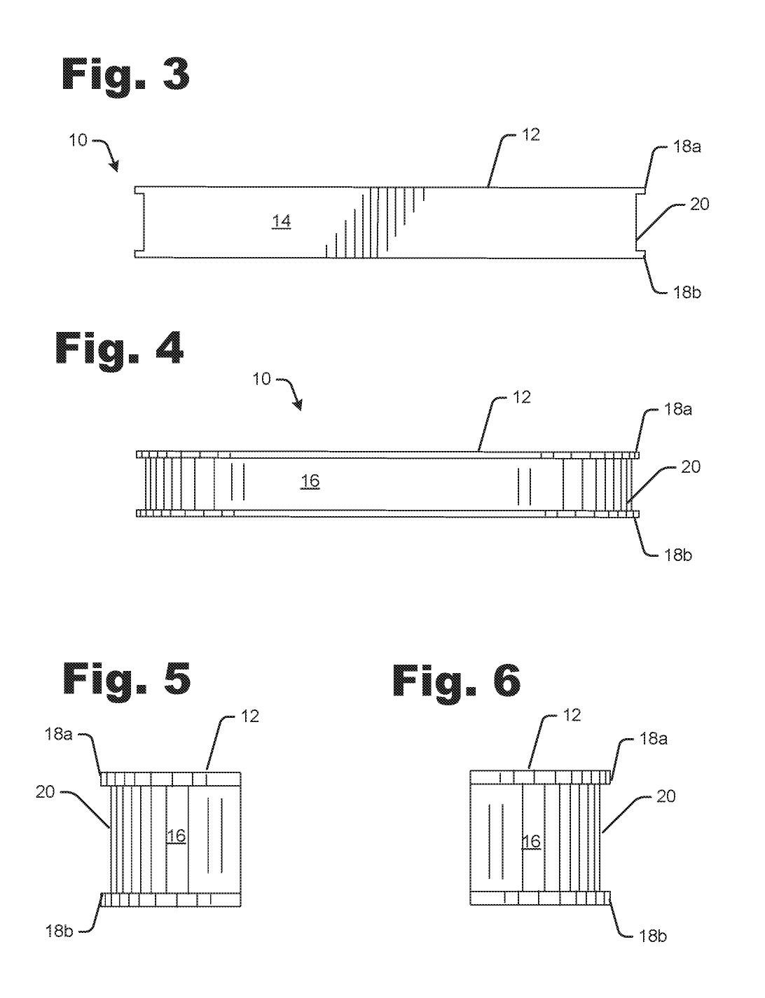

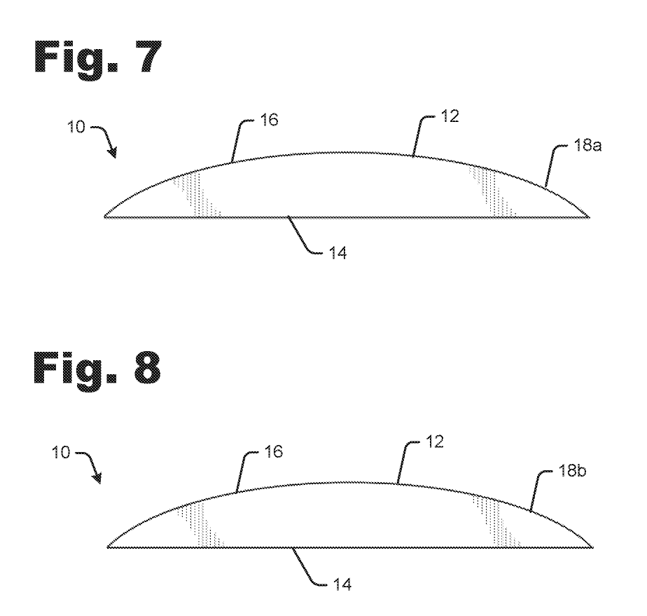

FIG. 1 is a top perspective view of an example post clamp 10. FIG. 2 is a bottom perspective view of the example post clamp 10. FIG. 3 is a rear view corresponding to FIG. 1. FIG. 4 is a front view corresponding to FIG. 1. FIG. 5 is a right-side view corresponding to FIG. 1, FIG. 6 is a left-side view corresponding to FIG. 1. FIG. 7 is a top view corresponding to FIG. 1. FIG. 8 is a bottom view corresponding to FIG. 1. In an example, the post clamp 10 provides a water tight seal on a square post, tubing, or other surface.

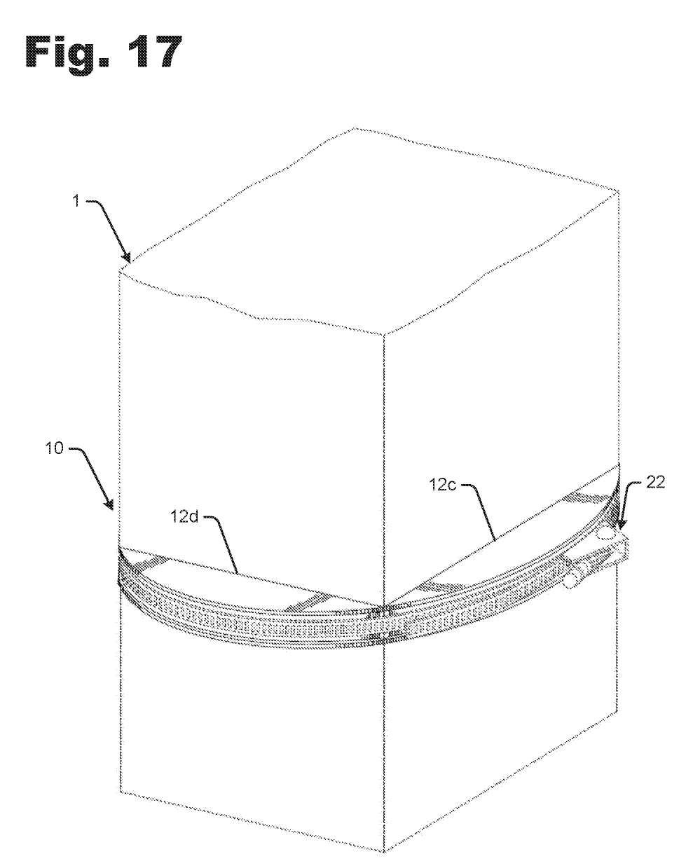

In an example, the post clamp 10 includes a buffer component 12 with a first surface 14 on a post side, as can be seen in FIG. 3. The buffer component 12 also has a second surface 16 on an opposite or clamp side, as can be seen in FIG. 4. The buffer component 12 is positionable about at least a portion of a post (e.g., adjacent a surface of the post, and fastened to the post by a strap on the opposite side (see, e.g., FIG. 17 discussed below).

In an example, the post clamp 10 also includes a strap. The strap may be any suitable fastener, such as but not limited to a hose clamp. The hose clamp is configured to fasten about at least one buffer component 12 and the post to secure the at least one buffer component to the post.

The buffer components 12 may be provided in multiple sizes to accommodate different sizes of posts or tubing (or other objects). In an example, the post side 14 of the buffer component 12 is substantially flat. In other examples, the post side 14 of the buffer component 12 may also be shaped to accommodate other surface shapes (e.g., a round post, not shown).

In an example, the opposite side or clamp side 16 is substantially arc shaped. The clamp side 16 may be configured so as to form a circle when placed about a square post (see, e.g., FIG. 17). According to this configuration, the clamp side 16 is not circular by itself, but forms a circle based on a radius extending to the center of the post (i.e., the distance from the center of the post to one of the corners of the post).

In an example, the arc can be thought of as being “moon” shaped (e.g., when waxing or waning) or banana shaped. This shape of an exterior of each buffer component 12 enables substantially equal pressure to be applied to all surfaces of the post in a uniform manner. The flat surface 14 of the interior of each buffer component 12 enables a tight fit against a post or tubing.

In an example, the clamp side 16 of the buffer component 12 includes upper and lower ridges 18a-b on either side forming a valley 20 between the ridges 18a-b. The valley 20 accommodates a fastener configured to sit within the valley 20 between the ridges 18a-b. The ridges 18a-b maintain the fastener in the valley 20 on the buffer component 12, and keeps the fastener from slipping or sliding partially or fully off of the buffer component 12 during tightening and/or after installation.

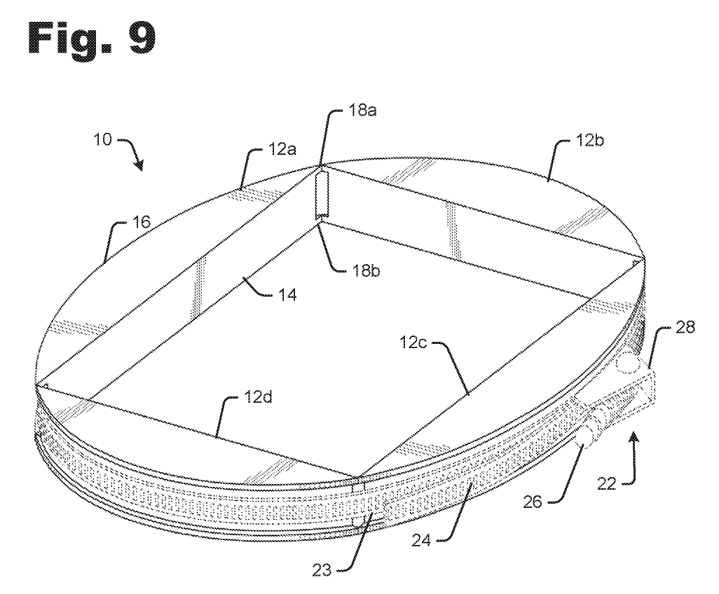

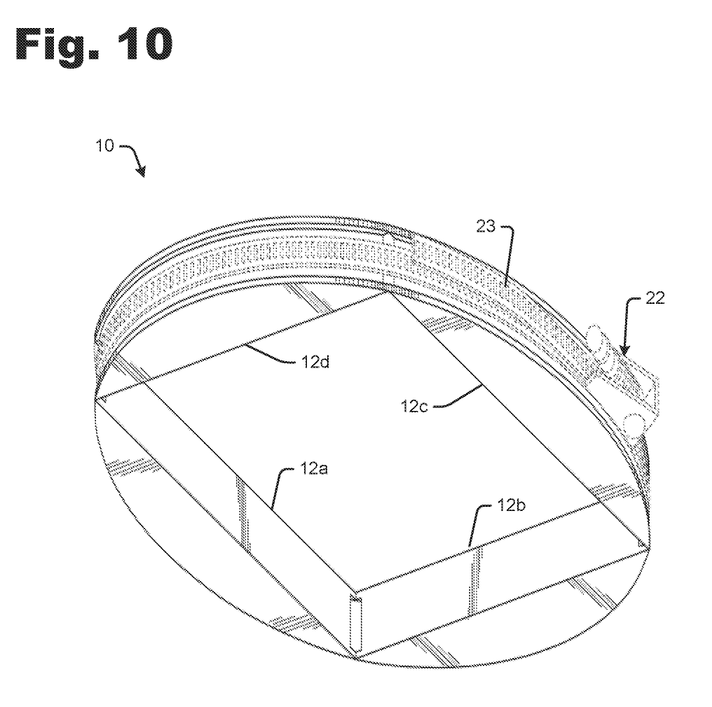

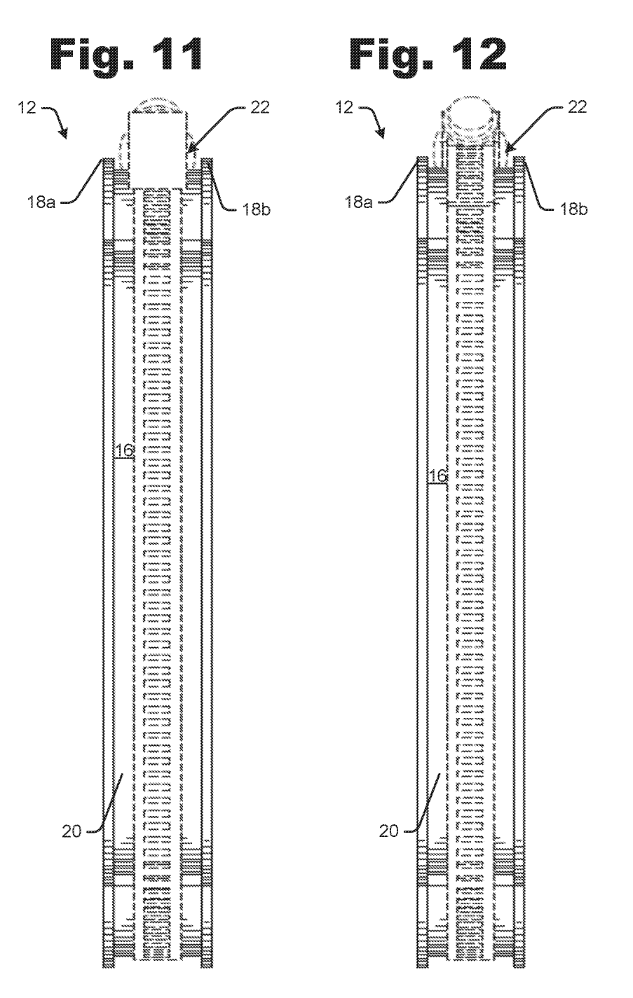

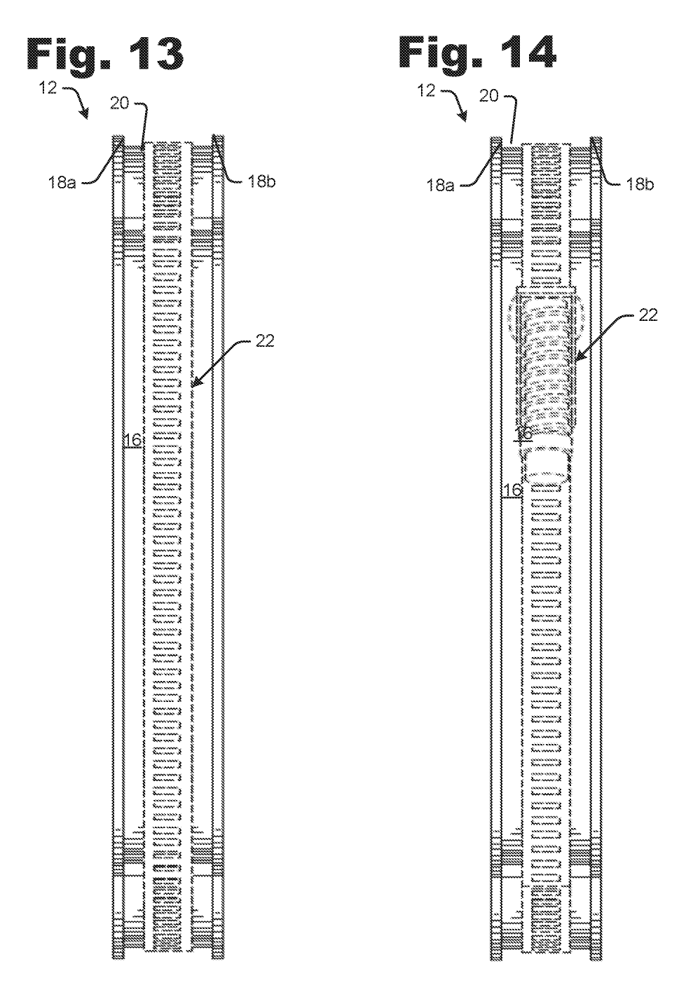

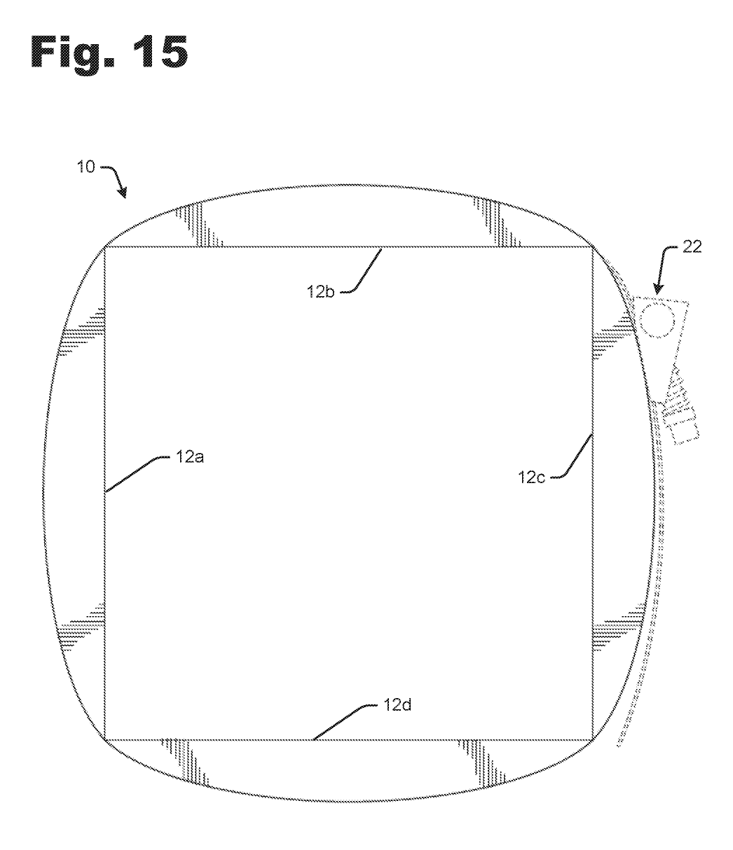

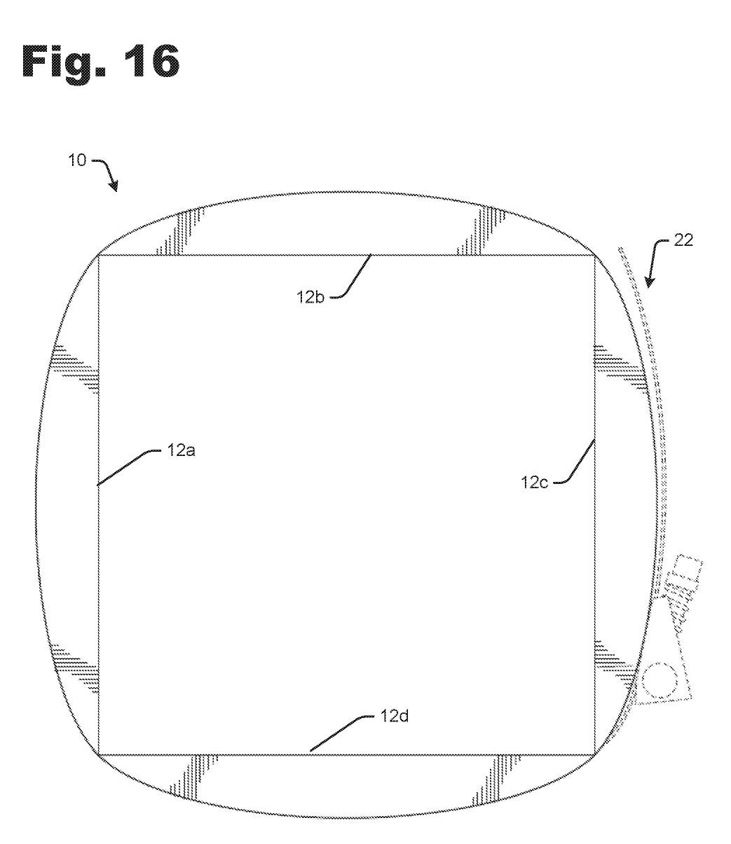

FIG. 9 is a top perspective view of multiple post clamps 10a-d corresponding to the post clamp 10 of FIG. 1, combined with a strap 22 (e.g., hose clamp) as it may be configured to fit about a square post. FIG. 10 is a bottom perspective view corresponding to FIG. 9. FIG. 11 is a front view corresponding to FIG. 9. FIG. 12 is a rear view corresponding to FIG. 9. FIG. 13 is a right-side view corresponding to FIG. 9. FIG. 14 is a left-side view corresponding to FIG. 9. FIG. 15 is a top view corresponding to FIG. 9. FIG. 16 is a bottom view corresponding to FIG. 1. It is noted that the strap 22 is shown in the drawings in dashed lines to better see how it can be fastened to the buffer component 12.

The example post clamp 10 may include any number of buffer components 12. In the FIGS. 9-16, the post clamp 10 is shown as it may be configured with four buffer components 12a-d and a hose clamp 22.

The hose clamp 22 may include a band 23 with a plurality of generally rectangular shaped openings 24 forming a screw or thread pattern for engagement by a threaded tightener 26 mounted on support 28. However, the fastener 22 is not limited to being a worm-gear type hose clamp. Other hose clamps (e.g., that are tightened with other mechanisms) are also contemplated. Other fasteners are also contemplated, as will be readily appreciated by those having ordinary skill in the art after becoming familiar with the teachings herein. Still other fasteners may include, but are not limited to, spring clamps, wire clamps, ear clamps.

Likewise, other configurations of the buffer component 12 may also be provided. For example, the buffer component 12 need not include ridges 18a-b and valley 20, or more include multiple ridges and valleys.

In another example, the buffer component 12 may include straps (not shown) extending fully or partially from ridge 18a to ridge 18b at one or more locations across the valley 20 to further assist in retaining the hose clamp 22 in a predetermined position.

In still another example, the buffer component 12 may include a tunnel (not shown) wherein the band 23 may be fit within the tunnel. Yet other configurations are also contemplated, as will be readily appreciated by those having ordinary skill in the art after becoming familiar with the teaching herein.

The post clamp 10 is illustrated as it may be attached to a four-sided post 1 (see, e.g., FIG. 17 discussed below). However, the post clamp 10 may include any number of buffer components 12 so that it may be fastened to any number of sides of the post 1 (e.g., one side, two sides, etc.).

As such, the post clamp 10 may be fastened to any configuration post (e.g., square, rectangular, hexagonal). In other examples, the post side 14 of the buffer component 12 may also be shaped to accommodate other surface shapes (e.g., a round post, not shown).

FIG. 17 is a perspective view of the post clamp 10 as it may be secured to a post 1. It is again noted that the strap 22 is shown in the drawings in dashed lines to better see how the post clamp 10 can be fastened to the buffer component 12. Likewise, the post 1 is shown in dashed lines as the post 1 is merely illustrative of an exemplary use-case for the post clamp 10 and is not intended to be limiting in any respect.

The buffer component 12 is positionable about at least a portion of a post (e.g., adjacent a surface of the post 1), and fastened to the post by a strap 22 on the clamp side 16.

Although shown attached to a four-sided post 1, the post clamp 10 may be fastened to any number of sides of the post 1 (e.g., one side, two sides, etc.). In addition, the post clamp 10 may be fastened to any configuration post 1 (e.g., square, rectangular, hexagonal).

In other examples, the post side 14 of the buffer component 12 may be shaped to accommodate other surface shapes (e.g., a round post, not shown). Likewise, the post clamp 10 is not limited to being fastened to posts 1, and can be fastened to any desired surface.

It is noted that the examples shown and described are provided for purposes of illustration and are not intended to be limiting. Still other examples are also contemplated.

1. A post clamp, comprising:
at least one buffer component having a first shape on a post side and a second shape on an opposite side, the at least one buffer component positionable about at least a portion of a post and fastened to the post by a strap on the opposite side.

2. The post clamp of claim 1, wherein the strap is a fastener.

3. The post clamp of claim 2, wherein the fastener is a clamp configured to fasten about the at least one buffer component and the post to secure the at least one buffer component to the post.

4. The post clamp of claim 1, wherein the opposite side of the at least one buffer component includes ridges on either side forming a valley between the ridges.

5. The post clamp of claim 4, wherein a fastener is configured to sit within the valley between the ridges.

6. The post clamp of claim 4, wherein the ridges maintain the fastener on the at least one buffer component and keep the fastener from slipping partially or fully off of the at least one buffer component.

7. The post clamp of claim 1, further comprising four buffer components, one buffer component to mate with each of four post sides.

8. The post clamp of claim 1, wherein the post side is substantially flat.

9. The post clamp of claim 1, wherein the opposite side is substantially arc shaped.

10. A post clamp, comprising:
at least one buffer component having a first surface on a post side and a second surface on an opposite side; and
a fastener configured to strap the at least one buffer component against a post.

11. The post clamp of claim 10, wherein the fastener is a hose clamp configured to secure the at least one buffer component to the post.

12. The post clamp of claim 10, wherein the opposite side of the at least one buffer component includes ridges.

13. The post clamp of claim 12, further comprising a valley formed between the ridges.

14. The post clamp of claim 13, wherein the fastener is configured to sit within the valley between the ridges.

15. The post clamp of claim 14, wherein the ridges maintain the fastener on the at least one buffer component and keep the fastener from slipping partially or fully off of the at least one buffer component.

16. The post clamp of claim 1, further comprising four buffer components, one buffer component to mate with each of four post sides.

17. The post clamp of claim 1, wherein the post side is substantially flat.

18. The post clamp of claim 1, wherein the opposite side is substantially arc shaped.

19. A post clamp, comprising:
a plurality of buffer components, each buffer component having a first surface on a post side and a second surface on a strap side, wherein the post side is substantially flat and the strap side is substantially arc shaped; and
a fastener configured to strap the at least one buffer component against a post to secure the at least one buffer component to the post.

20. The post clamp of claim 19, wherein the strap side of each of the buffer components has ridges forming a valley between the ridges, and wherein the fastener is configured to sit within the valley between the ridges so that the ridges maintain the fastener each of the buffer components and keep the fastener from slipping partially or fully off of the buffer components.
